(19) United States
(12) Patent Application Publication
(10) Pub. No.: US 2003/0097864 A1
(43) Pub. Date: May 29, 2003

(54) Hydroabsorbent soil conditioner

(76) Inventors: Eduardo Montes, Ft. Lauderdale, FL (US); Irma Montes, Ft. Lauderdale, FL (US)

Correspondence Address: Henry S. Kaplan, Esq., Feldman, Gale & Weber, P.A., Suite 1920, 201 South Biscayne Boulevard, Miami, FL, 33131, US

(21) Appl. No.: 10/255,404

(22) Filed: Sep. 26, 2002

(30) Foreign Application Priority Data
Oct. 10, 2001 (PE) 000997-2001/0IN

(51) Int. Cl. C05C 7/00

(52) U.S. Cl. 71/57

(57) ABSTRACT

The invention pertains to a compound used as a soil additive to enhance farming, forestry, ornamental and landscaping production in conditions of droughts and insufficient fertile soils. This composition contains potassium based absorbent acrylamide crossed linked copolymers, together with nutritional elements of fast and slow solubility, derived from mineral and organic substances, including in some cases, extracts from sea kelp as growth stimulants. This soil additive is used in varied dosages according to the type of crop, soil and climate. In field tests it has demonstrated great efficiency in enhancing crop production and/or higher quality crops and/or larger bloom and/or saving of irrigation water.

### BACKGROUND OF THE INVENTION

1. Field of the Invention

The present invention relates to a hydro absorbent compound used as a soil additive. This formula contains a compound comprising cross-linked potassium based highly absorbent copolymers together with slow and fast soluble nutrients obtained from mineral and organic substances including in some cases extracts from sea kelp, as growth stimulants.

Hydro absorbent polymers are used to solve water shortage problems especially in places where only rainwater is available for shorts periods every year. These copolymers have the ability to absorb and adsorb water and water soluble substances dissolved in the water.

2. Description of Related Art

Hydro absorbent polymers used as soil additives to enhance water availability in plants have been researched for many years, but only since 1990, has their use has been considered feasible, mainly due to their high cost and toxicity. These factors have been corrected or eliminated in some type of copolymers presently available.

In patent application WO98/12154 it is mentioned that Fikhof studied the influence of a hydrophil polymer in water requirements for pots and containers. This same patent application mentions that Ghering and Lewis reported the effect of hydrogels in wilted and drought stressed nursery plants. Later, W. G. Pill studied the use of acrylamide based polymer gels as growing media for tomato seedlings because the hydrogels showed sensibility in the presence of salts. This resulted in the focusing of attention towards the acrylamide polymers instead of the ionic acrylates, even though the super absorbent acrylamides showed less water absorption qualities in the presence of soluble salts.

In patent application WO9812154 it is also mentioned that sodium polyacrylate polymers tend to condensate during drought periods, forming cross-links which inhibit re-initiation process when they are re-humidified, even when they are used in limited humidity and drought cycles. It is also mentioned that sodium polyacrylate inhibits plant growth and in some cases is even toxic to plants.

This inhibition of growth or toxicity is believed to be caused by the presence of sodium ions in the sodium polyacrylate chain which are exchangeable. These ions are absorbed by clay particles or otherwise tend to suffer cation exchange with the plant roots surface. As a consequence, it yields a condition analogous to an alkaline soil which generally tends to affect or inhibit plant growth.

Potassium based acrylamide copolymers, like the ones described in U.S. Pat. No. 5,649,495, have been proven to have greater gel stability under soil pressure, less cost and no toxicity. The formula that contains the potassium ion as organizing axis of the copolymeric chains is not toxic and it does not damage the plants, according to Williams, who is mentioned in patent application WO98/12154. U.S. Pat. No. 5,209,768 describes an acrylamide copolymer in liquid gel form for the improvement of sod growth and promotion of root growth.

The potassium/ammonium based acrylamide copolymers of the present invention are known in the prior art and have been used as soil additives.

Patent application EP0386345 refers to an invention containing nutrients for soil, without mentioning in what proportions and describes a rate of application of the product described as 5 kgs.(11 lbs.) per cubic meter of soil. The present invention achieves its results much more economically and with greater water retention rates as explained herein.

### BRIEF SUMMARY OF THE INVENTION

In order to improve and achieve adequate soil humidity, raise nutrition standards and create favorable conditions for a microbiological development of the soil, the present invention relates to a new formula comprising a blend used as a soil additive for the improvement of the soil containing the aforementioned known polyamide/polyacrylate copolymer together with organic and mineral nutrients presented as slow release and fast solubility fertilizers. A second embodiment of the invention includes the addition of sea kelp, which formula has broader nutritional properties through the inclusion of additional vitamins and proteins. These compositions offer a synergy over use of the individual ingredients alone.

### DETAILED DESCRIPTION OF THE INVENTION

The absorbent qualities of the new formula consist of the aforementioned copolymer which has previously been used alone as a soil additive and contains by weight, 4-6% acrylic acid, 30-40% acrylamide, 40-50% potassium polyacrylate, 4-6% ammonium polyacrylate and 7.5-9% water. The copolymer is included in the composition of the present invention in a ratio of 60-90% of the total weight of the composition.

The primary characteristic of the copolymer is water retention through mechanisms of absorption and adsorption. This means that water enters and also adheres to the copolymer particles. The hydric retention is present in chemical links known as a “hydrogen bridge”. They present a definite affinity with water molecules.

The mineral and organic components, which are present in this invention in a proportion ranging between 0.86-1.57%, are dispersed in the soil because of the presence of an inert carrier material which may be found in a proportion from 2% to 7.5% of the composition of the invention. Each component contributes an unexpected synergy to the recuperation of the soil microbiology.

The substances that are released through the slow release fertilizers and organic soluble fertilizers and the sea kelp, are stored in the copolymer or together with the copolymer and in the soil solution in the vicinity of feeding roots without being lost or transferred to deeper layers by lixiviation. The sea kelp have the following substances: essential amino acids (histine, isoleucine, leucine, lysine, methionine, phenialanine, treonine, tryptophane, and valine), non essential amino acids (alanine, aspartic acid, cistine, glycine, glutamic acid, proline, serine and tyrosine), and vitamins (C-ascorbic acid, vitamin E: tocopherol, Vitamin A: fucoxantine, carothene, menadione K 3, riboflavine B2, Tiamine B1, pantothenic acid B5, Piridoxine B6, Folic acid B9, biothine H, cobalamine B12 and colecaldiferol D3).

The slow release fertilizers are encapsulated such that they only start to mobilize to the exterior when the soil temperature is above 15 degrees C. The degree of fluidity of the nutrients diminishes in cold weather, therefore, the fertilizers are available during a period ranging from 10-18 months. This reduces fertilizing cost. The soluble fertilizers are dissolved rapidly in the water, which in turn is absorbed by the copolymer. The quick soluble fertilizers accomplish immediate rehabilitation of plants that may be weak due to lack of nutrients. The slow release organic fertilizers biologically nurture the soil. This yields a benefit to the microbiological system which stimulates it to multiply, achieving a better response to organic other fertilizations that may occur later in the soil.

Sea kelp provides complementary nutritional aspects that normally are not considered in mineral fertilization. The synergy of these elements promotes the microbial activity on the soil encouraging humus formation, which is the main nutritional support of plants.

The invention has neutral pH and is capable of regulating pH no matter the tendency of soil (acid or alkaline).

The potassium and ammonium based copolymers of this invention are non-toxic for plants, soil microorganisms and under ground/surface water because they include an almost imperceptible quantity of free monomers (less than 25 mg/kg for acrylamide and less than 600 mg/kg for acrilic acid).

In an embodiment of the present invention the composition used as an additive to condition the soil includes a composition comprising:

The below described potassium and ammonium based acrylamide copolymer in a proportion of 60% to 95% of the total weight of the total composition;

Pyroclastic rock as a carrier in a proportion of 3% to 28% of the total weight of the composition; and

A mineral based nutrient in a proportion of 2% to 12% of the total weight of the composition.

The potassium-ammonium acrylamide copolymer comprising:

Acrylamide in a proportion of 30% to 40% of the total weight of the copolymer;

Acrylic acid in a proportion of 4% to 6% of the total weight of the copolymer;

Ammonium polyacrylate in a proportion of 4% to 6% of the total weight of the copolymer;

Potassium polyacrylate in a proportion of 40% to 50% of the total weight of the copolymer; and

Water in a proportion of 7.5% and 9.5% of the total weight of the copolymer

In another embodiment the composition is used as an additive to condition the soil and comprises:

The above-described copolymer in a proportion of 70% to 88% of the total weight of the composition;

Pyroclastic rock as a carrier material in a proportion of 9% to 24% of the total weight of the composition; and

Mineral based nutrient in a proportion of 3% to 6% of the total weight of the compound.

In another embodiment of the invention the composition is used as an additive to condition the soil and comprises:

The above-described copolymer in a proportion of 60% to 92% of the total weight of the composition;

A polyclastic rock in a proportion of 2% to 21% of the total weight of the composition; and

A mineral based nutrient in a proportion of 3% to 8.5% of the total weight of the composition; and

A sea kelp based organic nutrient in a proportion of 5% to 10.5% of the total weight of the composition.

In another embodiment the composition is used as an additive to condition the soil and includes:

The above-described copolymer in a proportion of 65% to 86% of the total weight of the composition;

Pyroclastic rock as a carrier material in a proportion of 7% to 18% of the total weight of the composition;

Mineral based nutrient in a proportion of 2% a 6.5% of the total weight of the composition; and

Sea kelp based organic nutrient in a proportion of 3% to 10.5% of the total weight of the compound.

In the present invention, the term “hydro absorbent” should be understood as absorbent and/or adsorbent. The nutritious substances are based on Nitrogen, Potassium, Phosphorus, Calcium, Sulphur, Magnesium, Iron, Molybdenum, Copper, Zinc, Manganese and Boron. These nutrients are combined to form complex fast and slow solubility fertilizers. They act in synergy with the copolymer, without regard for their own level of concentration.

The invention is comprised of the afore-described copolymer in a proportion of 60% to 95% by weight of the total composition, and preferably between 70% and 88% by weight of the total composition. The variation exists because different soils and plants have different water and nutrient requirements. The copolymer is biodegradable, non-toxic and does not pollute soils or ground water.

Water inside the copolymer is fixed inside the chemical structure and does not leak because of the known hydrogen bridge structure which the water molecule forms with the copolymer. This type of link has an affinity for water molecules and is responsible for the water being stored inside the molecule with a retention force or negative pressure of 0.33 to 15 bars, the same superficial tension range that plants need to survive. Water enters the copolymer and expands the soil, forming cavities in the ground, so that water, air and new roots can enter the voids. The dynamics of the expansion and contraction cycle of the copolymer granules depends on the water requirements of the crops and availability of watering/irrigation. Each cycle enhances soil porosity and improves aeration. This is important in the process of cellular breathing and ammonium oxidation, which is easier for the plants to assimilate as NO3 rather than as NH4+, which develops toxins in oxygen deprived soil.

The hydro absorbent copolymer is pH neutral, with a 7 pH value. It can regulate pH regardless of the soil type (alkaline or acid). The Potassium ions partially yield space to other ions, such as Sodium, and as a result alkaline elements are forced out of the soil solution. After a treatment with calcium carbonates, the sulphates or carbonates formed fall without harmful effects. Tests have shown pH values lowered from 9 to 7 and even to 6.5. When the soil solution has a low pH value (many free hydrogen ions), the radical amide ion (NH2−) which is also part of the copolymer retains and blocks those ions because it has affinity for the hydrogen ion. The captured ion forms water molecules, hydroxides and organic acids.

The mineral and organic elements present in this invention work in synergy to recuperate soil microbiology, and provide nourishment that beneficial fungus and bacteria needed for the optimal exchange of cations, oxygen, hormones, vitamins and CO2 with the plant roots. Slow release, soluble organic fertilizers and sea kelp extracts deliver substances that remain stored inside the copolymers and the soil solution avoiding waste and movement away from the feeding roots. The copolymers store these substances until the roots demand them through suction.

The slow release fertilizers are encapsulated so that the elements they contain are activated when temperatures reach 15 degrees C. As temperature increases, so does the fluidity of the nutrient. This characteristic of the invention is critical for the conservation of nutrients during cold season watering periods. Plant metabolism and nutrient consumption is reduced during the colder winter months. Therefore, if fertilizers are not controlled by outside temperature, they will dissolve in water and gravitate toward deeper layers rather than remaining in close proximity to feed the plant. Unlike other products in the market, this characteristic of the invention reduces fertilizing costs and promotes vigorous and steady growth because applied fertilizers remain available to the plant 10 to 18 months.

The nutrient retention is designed so that a plant may access them at the time and the amount they are needed. Thus, fertilizers are not wasted with simple watering, yielding a much more economical product.

The fast soluble fertilizers dissolve rapidly in water which is then absorbed by the copolymer. These soluble fertilizers are available for immediate rehabilitation of weak and underdeveloped plants.

The organic fertilizers, which are also slowly delivered into the soil, provide biological nourishment. This means that the microbiological system in the soil is favored and motivated to multiply. This facilitates a better response to further organic fertilizations in the soil.

When the product contains at least 5% sea kelp, the vitamin and protein compound enhances the nutritional value of treated plants and soils. The addition of sea kelp improves rehabilitation of microbial presence in the soil. This means that poor soils can become active and capable of responding well to organic and inorganic fertilizer application because the organisms responsible for organic matter combustion and soil oxygenation are increased in number. Sea kelp contains microelements, 14 vitamins-including vitamin B12−(not found in terrestrial plants) and vitamin E, with a complex variety of isomers, only found in seed oil and wheat germ oil. It also has 16 amino acids, phytohormones such as cytoquinine, axing and gibereline. These components complement the nutrients aspects not normally considered in mineral fertilization. The synergy of these elements promotes microbial activity in the soil, and triggers a sequence of biochemical reactions, which develop into humus in the soil, which comprises the main source of nutritional support for the plants. All these components act in synergy promoting an interaction between the biotic and abiotic elements of the soil.

The greater availability of water in the soil increases available nutrients and fosters root growth, which promotes more vigorous plants. The root system tends to grow to greater size because when plants require more water, the root system expands to access the water source available in the copolymer gel granules suspended in surrounding soil. Tests show that application may not result in immediate obvious growth because underground development begins first. However, after a short period, many new sprouts will appear.

Water release is accomplished through osmosis. The hydrated granules in the copolymer release water only if surrounding materials have a lower concentration of water than that inside the granules. This reduces water loss due to percolation or evaporation. Therefore, humidity concentration levels do not change drastically, avoiding drought stress in the plant and considerable loss of the elements applied to the plant and soil, all of which combine to improve production yield. Osmotic strength depends on water and soil quality, because the strength exerted against the gel is controlled by the water and salt concentration in the soil or growing media. Therefore, water is released when salt concentration outside the gel is greater than within and enters. For this reason, hydro absorbent copolymers do not reach their maximum size when salt water is used.

The copolymer remains active in the soil for over 5 years. Its degradability is not complete during that time due to the chemical reaction that causes the humification of organic matter. This is evidence that the copolymer is non-toxic and completely degradable. By the end of its active life, it remains in the soil as a potassium residue, which is a nutrient.

Gravitational water in the soil is the main carrier and means of detection of radicular exudates and sexual hormones of phytoparasite nematodes. The copolymers retain the water, hence reducing the opportunity for nourishment of nematodes and the chances of their reproduction. This reduces their population and related plant damage. Therefore, the copolymer allows the avoidance or reduced application of pesticides.

These copolymers elaborated with potassium ion and ammonium salt, posses an almost imperceptible quantity of free monomers (less than 25 mg/kg of product). Laboratory testing with the OECD method has qualified the copolymer as non toxic to plants, soil microorganisms, underground water and surface water.

### EXAMPLES

The following examples show different formulations of the hydro absorbent compound in various applications. Such examples are merely for illustrative purposes and as will be understood by those of ordinary skill in the art, these examples do not limit, in any way, the potential applications and formulations of the invention.

### Example 1

In the first formulation, the hydro absorbent composition comprising:

| | |
|---|---|
| The acrylamide copolymer as described above | 62% |
| Carrier Material | 27% |
| Nutrients | 11% |

On flowerbed tests, such as Hydrangea SP, the flower diameter of the bloom was increased over 30%. The blooming period was increased by 50%.

### Example 2

In the second formulation, the hydro absorbent composition comprising:

| | |
|---|---|
| The acrylamide copolymer as described above | 87% |
| Carrier Material | 9% |
| Nutrients | 4% |

Forestry species such as Eucalyptus (Eucalyptus Rostrata) and Pine (Pinus Radiata), demonstrated a survival rate of 95% under conditions of 70 days without watering in very poor soil. Under similar circumstances, a control group without the application of the composition of the invention showed a survival rate of 0%, that is no plants survived.

### Example 3

In the third formulation, the hydro absorbent composition comprising:

| | |
|---|---|
| The acrylamide copolymer described above | 90% |
| Carrier Material | 4% |
| Nutrients | 1.7% |
| Sea kelp | 4.3% |

When this formulation was used in farming trials, production yield increased over 30% (100% in cold weather potato, 85% in oats, 55% in corn, 53% in sugarcane, 40% in asparagus and 35% in orange.)

### Example 4

In the fourth formulation, the hydro absorbent composition comprising:

| | |
|---|---|
| The acrylamide copolymer as described above | 67% |
| Carrying Material | 18% |
| Nutrients | 6.5% |
| Sea kelp | 8.5% |

On slope trials, this formulation controlled erosion when combined with hydro seeding systems. In slopes exceeding 45 degrees, more than 95% was successfully revegetated. Humidity retention and adequate application of the nutrients contained in this formula, which acted as a substrate, contributed to revegetate very poor degraded soils.

Typical formulations for the compositions of the present invention are shown in the following Tables:

TABLE NO 1

| | | | | |
|---|---|---|---|---|
| Acrylamide Copolimers | 95% | | 60% | |
| Carrier material (pyroclastic | 3% | | 28% | |
| rock) | | | | |
| N | 0.8% | | 7% | |
| P2O5 | 0.5% | | 3% | |
| K2O | 0.6% | | 1.8% | |
| B | 4 | ppm | 10 | ppm |
| Cu | 10 | ppm | 25 | ppm |
| MgO | 360 | ppm | 900 | ppm |
| Fe | 30 | ppm | 75 | ppm |
| Mn | 16 | ppm | 40 | ppm |
| Mo | 4 | ppm | 10 | ppm |
| Zn | 4 | ppm | 10 | ppm |
| Growth enhances | 472 | ppm | 1180 | ppm |

TABLE NO 2

| | | | | |
|---|---|---|---|---|
| Acrylamide copolymers | 88% | | 70% | |
| Carrier material-pyroclastic rock | 9% | | 24% | |
| N | 1.2% | | 3% | |
| P2O5 | 0.7% | | 1.1% | |
| K2O | 1% | | 1.7% | |
| B | 4 | ppm | 10 | ppm |
| Cu | 10 | ppm | 25 | ppm |
| MgO | 360 | ppm | 900 | ppm |
| Fe | 30 | ppm | 75 | ppm |
| Mn | 16 | ppm | 40 | ppm |
| Mo | 4 | ppm | 10 | ppm |
| Zn | 4 | ppm | 10 | ppm |
| Growth regulators | 472 | ppm | 1180 | ppm |

TABLE NO 3

| | | | | |
|---|---|---|---|---|
| Acrylamide Copolimers | 92% | | 60% | |
| Carrier material (pyroclastic | 2% | | 21% | |
| rock) | | | | |
| N | 0.8% | | 4% | |
| P2O5 | 0.2% | | 2% | |
| K2O | 0.4% | | 2% | |
| Ca | 1000 | ppm | 2500 | ppm |
| B | 10 | ppm | 24 | ppm |
| Cu | 8 | ppm | 19 | ppm |
| MgO | 770 | ppm | 1925 | ppm |
| Fe | 22 | ppm | 56 | ppm |
| Mn | 13 | ppm | 30 | ppm |
| Mo | 3 | ppm | 8 | ppm |
| Zn | 4 | ppm | 9 | ppm |
| Carbon hydrates | 3% | | 7.5% | |
| Proteins | 0.75% | | 1.25% | |
| Fibers | 0.5% | | 1% | |
| Vitamin | 500 | ppm | 1450 | ppm |
| Fat | 0.35% | | 0.56% | |
| Growth regulators | 375 | ppm | 375 | ppm |

TABLE NO 4

| | | | | |
|---|---|---|---|---|
| Acrylamide Copolimers | 86% | | 65% | |
| Carrier material (pyroclastic | 7% | | 18% | |
| rock) | | | | |
| N | 1% | | 3% | |
| P2O5 | 0.5% | | 1% | |
| K2O | 0.9% | | 2% | |
| Ca | 1000 | ppm | 2500 | ppm |
| B | 10 | ppm | 24 | ppm |
| Cu | 8 | ppm | 19 | ppm |
| MgO | 770 | ppm | 1925 | ppm |
| Fe | 22 | ppm | 56 | ppm |
| Mn | 13 | ppm | 30 | ppm |
| Mo | 3 | ppm | 8 | ppm |
| Zn | 4 | ppm | 9 | ppm |
| Carbon hidrates | | | 7.5% | |
| Proteins | 0.75% | | 1.25% | |
| Fibers | 0.5% | | 1% | |
| Vitamin | 500 | ppm | 1450 | ppm |
| Fat | 0.35% | | 0.56% | |
| Growth regulators | 375 | ppm | 940 | ppm |

This invention as opposed to similar ones relying on sodium-based copolymers, has a lower amount of free monomers which makes it fit for direct consumption horticulture. It also has the capacity to retain water in a mode that renders it available as soil and plant conditions require it. This means that the water is retained in the gel particles as time goes by, which does not occur with sodium based copolymer compounds.

This shows that the gel is stable in time regardless of how dry it might be after a drought period. Because the product will re-hydrate when irrigation resumes, the compound will behave as a newly applied product.

This invention surpasses those with 100% pure copolymers, because it contains nutrients that have shown to help plants react positively in periods as short as a few hours thereby decreasing damages due to stress and soil mishandling. The present invention is used in ratios ranging from 1 to 2 Kg per cubic meter of soil and water and nutrient retention capacities are 75% to 125% higher than the use of nutrient additives alone.

The nutritional quality of food is lower every day. This invention, allows nutrition levels of the population to be increased at no additional cost to the public; because plants will increase production of photosynthates due to the constant availability of water plus nutrients.

Also, application of this invention will promote an increase in the quality of previously degraded soils. The quality of life can be enhanced by the promotion of forests and green spaces, thus contributing to improve the environment.

Field tests have demonstrated that the independent application of each of the components of the invention (nutritional and hydro absorbent components) do not achieve the benefits of the composition of invention.

A large number of field tests have been conducted in diverse soils and climate conditions and have demonstrated that the effect of the potassium-based copolymer composition of this inventions to reduce plant mortality in drought conditions. It further reduces the incidence of nematodes by at least 95%. Significant increases in production against pilot/control groups of similar plants were documented during drought seasons, due to increased production through a better assimilation of nutrients, nutrient retention or the creation of better chemical soil conditions such as enhancing soil pH.

The results have been obtained on diverse agriculture and forestry crops. For example, on forage barley 85% more yield was obtained even under sporadic rain conditions. On potato, under the same conditions, a 150% increase in yield was achieved. On corn, a 100% higher yield was achieved and on high altitude cereals, such as quinoa and kiwicha, a 70% higher yield was achieved. Sugarcane yielded a 53% increase, and asparagus yielded a 25% increase on a desert with a soil temperature of over 50 C. (over 122 F.) carob trees achieved 95% survival rates against 87% mortality rate of control plants. On sandy beach areas subject to unfavorable conditions such as sea breeze, lack of soil and salt conditions, it is extremely hard to establish grass, however, using the invention, it was successfully performed.

Hydro-seeding tests were conducted to determine the invention's potential to control erosion on steep sloped sea side areas with almost no soil, obtaining 100% establishment. The species used was rye grass (lolium perenne) and the terrain included slopes exceeding 45 degrees of inclination and containing almost no soil or an extremely high surface stone content. The successful results are attributed to the combination of the hydro absorbent and the nutritional and organic components. Plant survival was possible with low water consumption even in extremely rocky areas. This test also demonstrated that unstable terrain on coastal cliffs could be controlled when the invention is applied to act as a substrate holding the plants, and providing the water and nutrients necessary for plant development.

In mining developments, with extreme weather, rugged lands and degraded soils it has been proven that the invention behaves as a substrate which helps rejuvenate areas affected by mining through regeneration.

The invention has helped obtain a less expensive product, that is more absorbent and with new nutritional elements such as the one from algae extract. This helped increase by at least 30% the benefits to the public through raw material savings and increased production.

The new organic substances in the invention help regain soil organic activity because it forms the nutritional platform of the soil making it stable. It also forms the colloid, the union of the organic and mineral parts.

After many years of thorough research on lands with diverse climates, soils and crop handling, we have discovered optimal dosage ranges to be used according to different crop types. Field tests have also shown reduced costs, increase in yields and profitability with better results.

What is claimed is:

1. A soil conditioning additive comprising:
a potassium-ammonium based copolymer in a proportion of 60% to 95% of the total weight of the composition;
pyroclastic rock as a carrier material in a proportion of 3% to 28% of the total weight of the composition; and
a mineral nutrient in a proportion of 2% to 12% of the total weight of the composition:
the aforesaid potassium-ammonium based copolymer comprising:
Acrylamide in a proportion of 30% to 40% of the total weight of the copolymer;
Acrylic acid in a proportion of 4% to 6% of the total weight of the copolymer;
Ammoniu polyacrylate in a proportion of 4% to 6% of the total weight of the copolymer;
Potassium polyacrylate in a proportion of 40% to 50% of the total weight of the copolymer; and
Water in a proportion of between 7.5% and 9.5% of the total weight of the copolymer.

2. The soil conditioning additive of claim 1 added to soil having a pH from about 6.5 to about 7.5.

3. The soil conditioning additive of claim 2 wherein the soil additive is added to soil in ratios ranging from 1 to 2 Kg per cubic meter for use in soil having a temperature of at least about 15 degrees Celsius.

4. A soil conditioning additive comprising:
a potassium-ammonium based copolymer in a proportion of 60% to 92% of the total weight of the composition;
a pyroclastic rock as a carrier material in a proportion of 2% to 21% of the total weight of the compound;
A mineral based nutrient containing plant growth regulators in a proportion of 3% to 8.5% of the total weight of the composition; and
sea kelp organic nutrient in a proportion of 5% to 10.5% of the total weight of the compound:
The aforesaid potassium-ammonium based copolymer comprising:
Acrylamide in a proportion of 30% to 40% of the total weight of the copolymer;
Acrylic acid in a proportion of 4% to 6% of the total weight of the copolymer;
Ammonium polyacrylate in a proportion of 4% to 6% of the total weight of the copolymer;
Potassium polyacrylate in a proportion of 40% to 50% of the total weight of the copolymer; and
Water in a proportion of between 7.5% and 9.5% of the total weight of the copolymer.

5. The soil additive of claim 4 added to soil having a pH from about 6.5 to about 7.5.

6. The soil conditioning additive of claim 4 where in the soil additive is added to soil in ratios ranging from 1 to 2 Kg per cubic meter for use in soil having a temperature of at least about 15 degrees Celsius.

7. A soil conditioning additive comprising:
a potassium-ammonium based copolymer in a proportion of 70% to 88% of the total weight of the composition.
a pyroclastic rock in a proportion of 9% to 24% of the total weight of the composition.
A mineral based nutrient in a proportion of 3% a 6% of the total weight of the compound.
the aforesaid potassium-ammonium based copolymer comprising:
Acrylamide in a proportion of 30% to 40% of the total weight of the copolymer;
Acrylic acid in a proportion of 4% to 6% of the total weight of the copolymer;
Ammonium polyacrylate in a proportion of 4% to 6% of the total weight of the copolymer;
Potassium polyacrylate in a proportion of 40% to 50% of the total weight of the copolymer; and
Water in a proportion of between 7.5% and 9.5% of the total weight of the copolymer.

8. The soil additive of claim 7 added to soil having a pH of from about 6.5 to about 7.5.

9. The soil conditioning additive of claim 7 wherein the soil additive is added to soil in ratios ranging from 1 to 2 Kg per cubic meter for use in soil having a temperature of at least about 15 degrees Celsius.
